(19) United States
(12) Patent Application Publication
(10) Pub. No.: US 2015/0112025 A1
(43) Pub. Date: Apr. 23, 2015

(54) HIGH EFFICIENCY POLYMER COMPOSITION

(71) Applicant: Axiall Corporation, Atlanta, GA (US)

(72) Inventors: Scott CHAMBERS, Goshen, CT (US); Davide ACHILUZZI, Maple (CA); Perry REED, Matawan, NJ (US); Chris TURNBULL, Barrie (CA)

(21) Appl. No.: 14/516,612

(22) Filed: Oct. 17, 2014

Related U.S. Application Data
(60) Provisional application No. 61/892,779, filed on Oct. 18, 2013.

(51) Int. Cl. C08L 27/06; C08L 21/00

(52) U.S. Cl. CPC C08L 27/06; C08L 21/00; C08L 2205/03
USPC 525/239; 525/55

(57) ABSTRACT

A high efficiency acrylic based impact modifier including a rubber weight fraction of at least 70% and an ultra-high molecular weight acrylic process aid with a molecular weight of at least 15 million grams/mol.

### CROSS-REFERENCE TO RELATED APPLICATIONS

The present application claims priority to U.S. Provisional Application No. 61/892,779 filed Oct. 18, 2013, the contents of which are incorporated herein by reference in their entirety.

### BACKGROUND OF THE INVENTION

The preparation of impact modifiers with either in situ prepared or intimately blended process aid(s) is not an uncommon practice; rheology, gloss, swell, metal release and melt strength can be altered and adjusted to desirable end by this method. It is however undesirable to detract from the impact modifier level when the level of the impact modifier is changed to lower levels. As cost is of prime consideration in polyvinyl chloride (“PVC”) formulation today, the industry has moved to displace the historically used acrylic impact modifiers in substrate (non-weathered) applications with lower cost chlorinated polyethylene (“CPE”). In order to compete against CPE, lower levels of the acrylic impact modifiers need to be used, but lowering the levels of acrylic impact modifiers can result in deleterious performance characteristics.

Higher molecular weight process aids can, at the same usage levels, impart greater melt strength, swell & gloss while retaining fusion promotion characteristics compared to the lower molecular weight process aids. Due to the greater influence on these characteristics in the PVC formulation it can be envisioned that a lower usage level of higher molecular weight process aids can displace higher levels of the lower molecular weight process aid to attain the same formulation characteristics and hence at lower cost. As the molecular weights are pushed upwards the evolution towards higher and ultra-high molecular weight process aids realize this efficiency more clearly.

### SUMMARY OF THE INVENTION

In embodiments of this invention, when the efficiency of ultra-high molecular weight process aids are intimately combined with higher efficiency impact modifiers the combination allows usage that provides improved performance over the same total level of impact modifier alone (performance characteristics) and at a usage level that is not cost prohibitive relative to CPE modified formulations. Additionally it is found that in general the performance characteristics and operating window is superior to the higher usage level required of the CPE modified formulation. It should be noted that the CPE modified formulations usually required a moderate level of medium molecular weight acrylic process aid to allow an acceptable processing window and generate an article that meets performance requirements.

### DETAILED DESCRIPTION OF THE INVENTION

For the embodiments of the invention described herein, a high efficiency acrylic impact modifier may be described as an acrylic based impact modifier with a rubber weight fraction equal to or greater than 70%, and a ultra-high molecular weight acrylic process aid can be any acrylic process aid that measures 15 million grams/mol or greater by the Gel permeation chromatography (“GPC”) method described later in this specification.

In an exemplary embodiment of the invention, a high efficiency impact modifier is combined with an ultra-high molecular weight process aid to create a high efficiency polymer composition. The ratio by weight of high efficiency impact modifier (“IM”) to ultra-high molecular weight process aid (“UHMWPA”) in an exemplary embodiment of the high efficiency polymer composition is 2.5:0.25 or approximately 91:9. In a second exemplary embodiment of the high efficiency polymer composition the ratio by weight of IM to UHMWPA is 2.75:0.25 or approximately 92:8. In other embodiments of the high efficiency polymer composition may realize performance benefits at a ranges of ratios by weight of IM to UHMWPA from 50:50 to 99:1.

The disclosed impact modifier with process aid packages can replace additive packages including CPE and acrylic process aids in a PVC formulation that is configured to accommodate the CPE processing.

Embodiments of the high efficiency polymer composition may be used in a PVC formulation at ranges from 2.75 to 4.0 parts-per-hundred resin by weight (“phr”).

Molecular weight assessment of ultra-high molecular weight acrylic process aids may be performed by dissolving the polymer in a suitable solvent, such as THF (tetrahydrofuran). The molecular weight may be analyzed using a Gel Permeation Chromatograph (“GPC”) system that includes: a Waters Corporation 1515 Isocratic HPLC Pump with a Waters Corporation 2414 Refractive Index Detector and a Waters Corporation 2487 Dual Wavelength Absorbance UV detector. The GPC is run with a continuous and constant flow of solvent and when a dissolved compound enters the detector it is registered as a change in the solvent (i.e. a change in refractive index or UV absorbance of the solvent) and so becomes detectable. The dissolved polymer however needs to be separated after injection through the pump but prior to running through the detectors using size exclusion columns (size or hydrodynamic volume is related to the molecular weight by way of a calibration) so that the polymer can be fractioned by molecular weight. To separate the dissolved polymer for resolving molecular weight distribution a guard column (Polyanalytik PAS-G) that contains a Teflon filter followed by a heated column bank that contains 2× PAS-106L (Polyanalytik) and 1× PLgel 10 um 500 A (Agilent) is installed on the system.

A modified universal calibration is set up using: Polystyrene standards (Polymer Laboratories) between 25K and 10M using 8 discrete data points. A calibration fit is done on those standards but is adjusted to best account for industry available materials of the type to be tested and with a reasonable confidence of where their molecular weights lie within that range. Similar products to those described in this document are also tested to ensure that the calibration is relevant. For ultra-high molecular weight acrylic process aid products that fall outside of this calibration range the calibration values are extrapolated.

The fusion performance, and impact performance of a control sample PVC component with a PVC formulation including a conventional acrylic process aid and CPE was tested versus test sample PVC components with a PVC formulations including an embodiment of the high efficiency polymer composition in place of the conventional acrylic process aid and CPE. The Control Sample included 1.00 parts per hundred resin (“phr”) of conventional acrylic process aid and 4.00 phr of CPE. Test Sample 1 replaces the standard acrylic process aid and CPE with 2.75 phr of a high efficiency polymer composition including a 2.50:0.25 ratio by weight of IM to UHMWPA. Test Sample 2 replaces the standard acrylic process aid and CPE with 3.00 phr of a high efficiency polymer composition including a 2.75:0.25 ratio by weight of IM to UHMWPA.

Table 1 shows comparative performance test results for the Control Sample and Test Samples 1 and 2. Fusion tests, including fusion time, fusion torque and stability time were performed under ASTM D2538 revision 2002, “Fusion of Poly(Vinyl Chloride)(PVC) Compounds Using a Torque Rheometer”, using a Brabender Intellitorque model. Impact tests were performed under ASTM D4226 revision 2000 “Standard Test Methods for Impact Resistance of Rigid Poly(vinyl chloride) (PVC) Building Products”. The tests include an ambient temperature normalized breakthrough energy test (“Procedure A at Ambient”), an ambient temperature normalized brittle point energy test (“Procedure B at Ambient”), a normalized break through energy test at −18° C. (“Procedure A at −18° C.”) and a normalized breakthrough energy test at −11° C. (“Procedure A at −11° C”). All impact tests were performed using the C.125 impactor head configuration in accordance with the ASTM D4226-00 test specification.

TABLE 1
Test Results

| | | | |
|---|---|---|---|
| | | | Test |
| Test | Control Sample | Test Sample 1 | Sample 2 |

ASTM D2538-02 Fusion Testing

| | | | |
|---|---|---|---|
| Fusion time (min) | 1:24 | 1:18 | 1:10 |
| Fusion Torque (mg) | 3,608 | 3,548 | 3,606 |
| Stability time (min) | 12.50 | 12.50 | 12.50 |

ASTM D4226-00 Impact Testing (inch * lbs/mil)

| | | | |
|---|---|---|---|
| Procedure A at Ambient | 0.801 | 0.818 | 0.990 |
| Procedure B at Ambient | 1.770 | 2.277 | 2.178 |
| Procedure A at −18° C. | 0.22 | 0.26 | 0.34 |
| Procedure A at −11° C. | 0.31 | 0.33 | 0.31 |

In the preceding specification, various embodiments of the invention have been described. It will, however, be evident that various modifications and changes may be made thereto, and additional embodiments may be implemented, without departing from the broader scope of the exemplary embodiments as set forth in the claims that follow. The specification is accordingly to be regarded in an illustrative rather than a restrictive sense.

What is claimed is:

1. A high efficiency polymer composition comprising:
a high efficiency acrylic impact modifier with a rubber weight fraction of at least seventy percent; and
an ultra-high molecular weight acrylic process aid with a molecular weight of at least fifteen million grams/mol.

2. The high efficiency polymer composition of claim 1, wherein the high efficiency acrylic impact modifier and the ultra-high molecular weight acrylic process aid are combined in a ratio by weight range from 50:50 to 99:1.

3. The high efficiency polymer composition of claim 1, wherein the high efficiency acrylic impact modifier and the ultra-high molecular weight acrylic process aid are combined in a ratio by weight of 2.5:0.25.

4. The high efficiency polymer composition of claim 1, wherein the high efficiency acrylic impact modifier and the ultra-high molecular weight acrylic process aid are combined in a ratio by weight of 2.75:0.25.

5. A polyvinyl chloride composition including the high efficiency polymer composition of claim 2, wherein the high efficiency polymer composition is in an amount of between 2.75 and 4.0 parts per hundred resin by weight.

6. A polyvinyl chloride component comprising the polyvinyl chloride composition of claim 5, wherein the polyvinyl chloride component has an ASTM D4226-00 normalized breakthrough energy greater than 0.810 inch-pounds per thousandth of an inch (in*lbs/mil) at an ambient temperature.

7. A polyvinyl chloride component comprising the polyvinyl chloride composition of claim 5, wherein the polyvinyl chloride component has an ASTM D4226-00 normalized brittle point energy greater than 2.0 inch-pounds per thousandth of an inch (in*lbs/mil) at an ambient temperature.

8. A polyvinyl chloride component comprising the polyvinyl chloride composition of claim 5, wherein the polyvinyl chloride component has an ASTM D4226-00 normalized breakthrough energy greater than 0.230 inch-pounds per thousandth of an inch (in*lbs/mil) at −18° Celsius.

9. A polyvinyl chloride component comprising the polyvinyl chloride composition of claim 5, wherein the polyvinyl chloride component has an ASTM D4226-00 normalized breakthrough energy greater than 0.300 inch-pounds per thousandth of an inch (in*lbs/mil) at −11° Celsius.
